(19) United States
(12) Patent Application Publication
(10) Pub. No.: US 2006/0034256 A1
(43) Pub. Date: Feb. 16, 2006

(54) System and method for service discovery during connection setup in a wireless environment

(75) Inventors: Sreenivas Addagatla, San Diego, CA (US); Sarvesh Asthana, San Diego, CA (US); Jagadish Maturi, San Diego, CA (US); Hemant Chaskar, Chelmsford, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/917,757

(22) Filed: Aug. 13, 2004

(51) Int. Cl. G06F 15/16; H04L 12/66

(52) U.S. Cl. 370/352; 709/227

(57) ABSTRACT

A system is provided that includes a network entity, such as a packet data switching node (PDSN), and a terminal capable of establishing a data-link connection with the network entity, such as after setting up a physical-layer connection with the network entity. After the data-link connection is established, the network entity and the terminal can configure a network-layer protocol such that data formatted in accordance with the network-layer protocol can thereafter be sent between the terminal and the network entity over the data-link connection. Then, during configuration of the network-layer protocol, the terminal can discover at least one service available to the terminal by receiving, from the network entity, a listing of the at least one available service. The listing of each available service includes an address of a provider of the available service and a port number and/or pathname for accessing the service at the provider.

### FIELD OF THE INVENTION

The present invention generally relates to systems and methods for service discovery in a wireless environment and, more particularly, to systems and methods for service discovery during connection setup in a wireless environment, particularly when roaming into a visited domain.

### BACKGROUND OF THE INVENTION

Where mobile telephones were perhaps viewed by many as a luxury when first introduced into the marketplace, they are today viewed by our society as very important, convenient, and useful tools. A great number of people now carry their mobile devices with them wherever they go. This popularity of wireless communication has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow audio communication, but also facilitate messaging, multimedia communications, e-mail, Internet browsing, and access to a wide range of wireless applications and services.

Although an incredible amount of content, applications, services, and the like is already available for use on wireless devices, current wireless specifications or protocols do not provide a universal, dynamic technique for the discovery of services available to mobile clients. In this regard, the Internet Engineering Task Force (IETF) request for comments document RFC 1661, entitled: The Point-to-Point Protocol (PPP), July 1994, defines a protocol for transporting multi-protocol data over point-to-point links. The contents of IETF RFC 1661, as well as any other IETF RFC identified herein, are hereby incorporated herein in their entirety. Mobile clients in wireless networks such as cdma2000 (as well as many wireless and wireline dial-up and digital subscriber line (DSL) services) access data services through PPP links. And as will be appreciated, PPP and similar connection-setup/boot protocols such as Dynamic Host Configuration Protocol (DHCP) and Bootstrap Protocol (BOOTP) provide clients with interface addresses and a number of other configuration parameters. As defined, PPP does provide authentication and negotiation of network layer parameters such as network addresses, default routers and the like. However, to discover available services, many clients use pre-configured values or external means such as Domain Name System (DNS) Services (SRV) records and Service Location Protocol (SLP) service agents. For more information on such DNS SRV records and SLP, see IETF RFC 2782, entitled: A DNS RR for Specifying the Location of Services (DNS SRV), February 2000; and IETF RFC 2165, entitled: Service Location Protocol, June 1997.

More particularly, the Internet Protocol (IP) Control Protocol (IPCP) is a PPP Network Control Protocol (NCP) to establish and configure parameters of IP version four (IPv4)-related parameters. Similarly, IPv6 Control Protocol (IP6CP) is a PPP NCP for IPv6-related parameters. Both IPCP and IP6CP allow configuration of interface addresses (IPv4 or IPv6 addresses) and provide an IP compression scheme, but do not provide configuration of services available to PPP clients. For more information on IPCP and IP6CP, see IETF RFC 1332, entitled: The PPP Internet Protocol Control Protocol (IPCP), May 1992; and IETF RFC 2472, entitled: IP Version 6 over PPP, December 1998. While PPP and the Microsoft extensions to the same provide for adequate configuration of PPP links, PPP does not specify service discovery during configuration or setup of PPP links.

Microsoft has defined two extensions to IPCP that do define configuration of DNS and Windows Internet Name Service (WINS) servers, in addition to the interface addresses and compression scheme, during configuration of PPP links. However, the Microsoft extensions to IPCP are specific to DNS and WINS services. In this regard, in a number of wireless networks such as cdma2000 networks, other services like Web proxy and/or Session Initiation Protocol (SIP) proxy services also must typically be configured, and PPP currently does not define a connection setup-time technique for configuring those other services, other than pre-configuring (or hard-coding) with respect to the client's home network. And for more information on the Microsoft extensions to PPP, see IETF RFC 1877, entitled: PPP Internet Protocol Control Protocol Extensions for Name Server Addresses, December 1995.

As will be appreciated, when a mobile client roams into another operator's domain, the server configurations with respect to the home network may not be optimal. Consider, for example, the case of a mobile client belonging to a United States operator's home domain in San Diego, Calif., where the mobile client accesses Web services via a Web proxy server that is pre-configured in the mobile client. Also, consider that the mobile client roams to the visited domain of a Korean operator in Seoul, South Korea. In order to access a Web service local to the mobile client in South Korea (located within the roaming area), the mobile client must still send Web requests to the Web proxy server in the US operator's domain. The Web requests then get routed back to the local Web server in South Korea, increasing the user response time. In such an instance, pre-configuring the mobile client only with respect to the home network clearly precludes the advantages of “locality of reference.”

As suggested above, DNS SRV records provide a service discovery technique. However, such a technique is external to PPP in that such a technique requires additional air-interface traffic between the mobile client and a DNS server. Similar observations hold true for the service discovery in accordance with SLP. It would therefore be desirable to design a system and method of service discovery during connection or link setup or configuration in a manner that is applicable to any of a number of different services that may be available to a mobile client, and in a manner that generally does not require pre-configuring the mobile client, additional signaling or subsequent network traffic.

### SUMMARY OF THE INVENTION

In light of the foregoing background, embodiments of the present invention provide an improved system and method for service discovery during connection setup in a wireless environment. The system and method of embodiments of the present invention allow a mobile terminal to discover any of a number of available service(s) in a manner that generally does not require pre-configuring the terminal, additional signaling or subsequent network traffic. More particularly, in accordance with embodiments of the present invention, as a terminal configures a network-layer protocol during setup of a connection with another entity, the entity is capable of providing the terminal with a listing of at least one service available to the terminal across the connection. As such, after establishing the connection, the terminal can access one or more of the listed service(s).

According to one aspect of the present invention, a system is provided that includes a network entity, such as a packet data switching node (PDSN), and a terminal capable of establishing a data-link connection with the network entity, such as after setting up a physical-layer connection with the network entity. After the data-link connection is established, the network entity and the terminal are capable of configuring a network-layer protocol such that data formatted in accordance with the network-layer protocol can thereafter be sent between the terminal and the network entity over the data-link connection. Then, during configuration of the network-layer protocol, the terminal is capable of discovering at least one service, such as a Web proxy service, at least one multimedia service, a service location protocol (SLP) service and/or a session initiation protocol (SIP) service, available to the terminal. In this regard, during configuration of the network-layer protocol, the terminal is capable of receiving, from the network entity, a listing of the at least one available service, the listing of each available service including an address of a provider of the available service and a port number and/or a pathname for accessing the service at the provider.

More particularly, to configure the network-layer protocol, the terminal can be capable of sending, to the network entity, a configure request including a service option identifying at least one service. In such an instance, the terminal can be capable of sending a configure request including a service option further identifying an application-layer protocol (e.g., http, ftp, rtsp, etc.) of at least one of the identified services. The network entity can then be capable of sending, to the terminal, a response including the listing of the at least one available service such that the terminal is capable of discovering the at least one available service based upon the response.

According to other aspects of the present invention, a terminal, network entity and method are provided for establishing a connection to a terminal. Embodiments of the present invention therefore provide an improved system, terminal, network entity and method of establishing a connection to a terminal to discover available services in a wireless environment. By allowing the terminal to discover available service(s) during setup of a connection with the terminal, the terminal may be capable of discovering available service(s) without participating in further network interactions with service provider(s) to discover the service(s) provided by such provider(s). And as will be appreciated, reducing such air-interface traffic is particularly advantageous in wireless environments where such traffic may be slow and costly. Also particularly advantageous for wireless environments and other low bandwidth-connected clients, embodiments of the present invention may save terminal response times by handling service interactions at locally available network entities, and may save further individual service discovery interactions.

Further, by allowing the terminal to discover available service(s) during connection setup, embodiments of the present invention can permit a terminal to discover available service(s) when the terminal roams into local, visited network domains. As such, the terminal's home domain, visited domain or both may be capable of assigning private network addresses (that need not be routable from Internet) to the terminal. In such instances, access to services using the local proxies can be beneficial over a network address translation (NAT) technique (i.e., no need to deploy NAT function that may be difficult to scale anyway for a large number of addresses). Therefore, the system, and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a communications system according to one embodiment of the present invention including a cellular network, at least one private network or domain, and a public network;

FIG. 2 is a schematic block diagram of an entity capable of operating as a terminal, PDSN, server, proxy and/or DNS server, in accordance with embodiments of the present invention;

FIG. 3 is a schematic block diagram of a mobile terminal, according to one embodiment of the present invention;

FIG. 4 is a control flow diagram of a terminal requesting content from a content provider when both the terminal and the content provider are located in a visited domain, the content being requested via a proxy in a home domain in accordance with a conventional technique where the terminal is preconfigured with the address of the home domain proxy;

FIG. 5 is a flowchart illustrating various steps in a method of establishing a connection to a terminal in accordance with one embodiment of the present invention; and

FIG. 6 is another control flow diagram of a terminal requesting content from a content provider when both the terminal and the content provider are located in a visited domain, but with the content being requested via a proxy also in the visited domain after service discovery in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

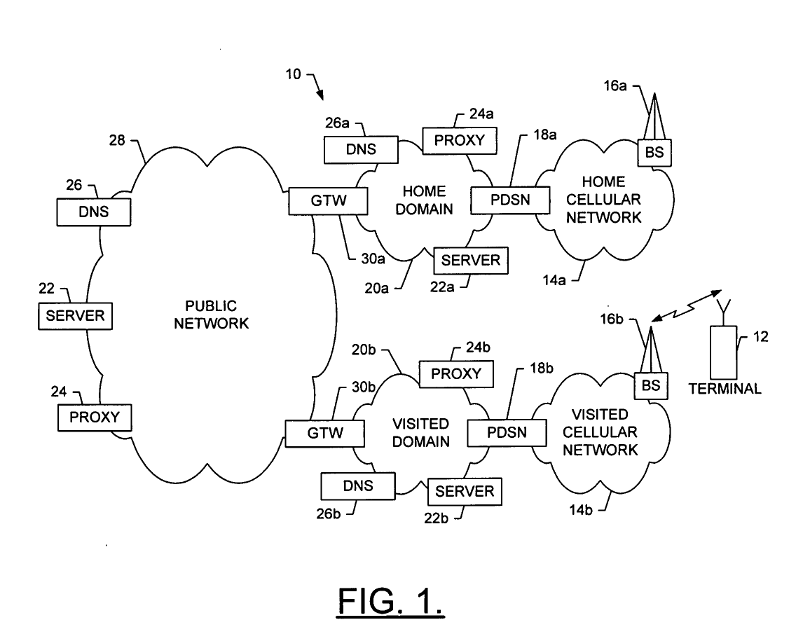

Referring to FIG. 1, an illustration of one type of system that would benefit from the present invention is provided. As shown, the system 10 includes a terminal 12 capable of being coupled to one or more mobile or cellular networks 14. The terminal can comprise any of a number of different mobile communication systems, devices or the like including, for example, a mobile telephone, portable digital assistant (PDA), pager, laptop computer or smart card. Likewise, the cellular networks can comprise one or more of a number of different mobile networks. In this regard, the cellular networks can comprise any of a number of first-generation (1 G), second-generation (2 G), 2.5 G and/or third-generation (3G) cellular networks, and/or any of a number of other cellular networks capable of operating in accordance with embodiments of the present invention. For example, each cellular network can comprise a GSM (Global System for Mobile Communication), IS-136 (Time Domain Multiple Access—TDMA), IS-95 (Code Division Multiple Access—CDMA), cdma2000, or EDGE (Enhanced Data GSM Environment) network. Alternatively, one or more of the cellular networks can comprise GPRS (General Radio Packet Service) or GPRS-based (e.g., Universal Mobile Telecommunications System—UMTS) networks.

As will be appreciated, the cellular networks 14 also include one or more network nodes. For example, cellular networks can include a base site or base station (BS) 16 to couple each terminal to the cellular network. As will be appreciated, the base station is a part of the cellular network, which can also include other elements required to operate the cellular network, such as a mobile switching center (MSC) (not shown). Also, although not shown, subscriber data of a terminal 12 can be permanently stored in a home location register (HLR) of one of the cellular networks, referred to herein as the “home cellular network” 14a. Likewise, subscriber data of the terminal can be temporarily stored in a visitor location register (VLR) of the visited cellular network when the terminal roams into another cellular network, referred to herein as the “visited cellular network” 14b. In this regard, the VLR contains selected administrative information necessary for call control and provision of the subscribed services for each terminal currently located in the geographical area of the cellular network controlled by the VLR. Although each functional entity can be implemented as an independent unit, manufacturers of switching equipment generally implement the VLR together with the MSC so that the geographical area controlled by the MSC corresponds to that controlled by the VLR, thus simplifying the signaling required.

The cellular networks 14 can further include a packet data serving node (PDSN) 18 to thereby couple the terminal 12 to a private network, domain 20 or the like (e.g., local area network—LAN). As will be appreciated, the domain coupled to the home cellular network 14, or more particularly the base station 16a of the home cellular network, is often referred to as the “home domain” 20a. In contrast, the domain coupled to the visited base station 16b of the visited cellular network 14a is often referred to as the “visited domain” 20b. In this regard, as shown, the system 10 includes PDSNs 18a, 18b for domains 20a, 20b, respectively.

The domains 20 can include a number of network nodes capable of providing a number of different services, each node typically comprising a processing element such as a server computer 22, personal computer, laptop computer or the like. More particularly, the domains can include one or more network nodes comprising a proxy 24 (shown as proxies 24a, 24b for domains 20a, 20b, respectively), such as a Session Initiation Protocol (SIP) proxy and/or a Web proxy. As will be appreciated, the SIP proxy is capable of receiving and forwarding SIP signaling messages, such as SIP signaling messages to and/or from a terminal operating as a SIP client. Similarly, a Web proxy is capable of receiving and forwarding network content such as Web content to and/or from a terminal operating as a Web client. In addition to the prox(ies), the domains can include one or more domain name system (DNS) servers 26 (i.e., shown as DNS servers 26a, 26b for domains 20a, 20b, respectively) capable of transforming a host DNS name into an associated IP address such that network traffic can be routed to the appropriate network node.

The domains 20 can be coupled to one another across a public network 28, such as a public Internet Protocol (IP) network like the Internet. Like the domains, the public network can include a number of network nodes, each of which typically comprise a processing element such as a server computer 22, personal computer, laptop computer or the like. More particularly, although the domains can be directly coupled to the public network, one or more of the domains are typically coupled to the public network via a gateway server (GTW) 30 (shown as GTWs 30a, 30b for domains 20a, 20b, respectively) interconnecting the public network and each domain. Also like the domains, the public network can include one or more network nodes comprising prox(ies) 24 and/or DNS servers 26 capable of performing the same or similar functions as those nodes of the domains.

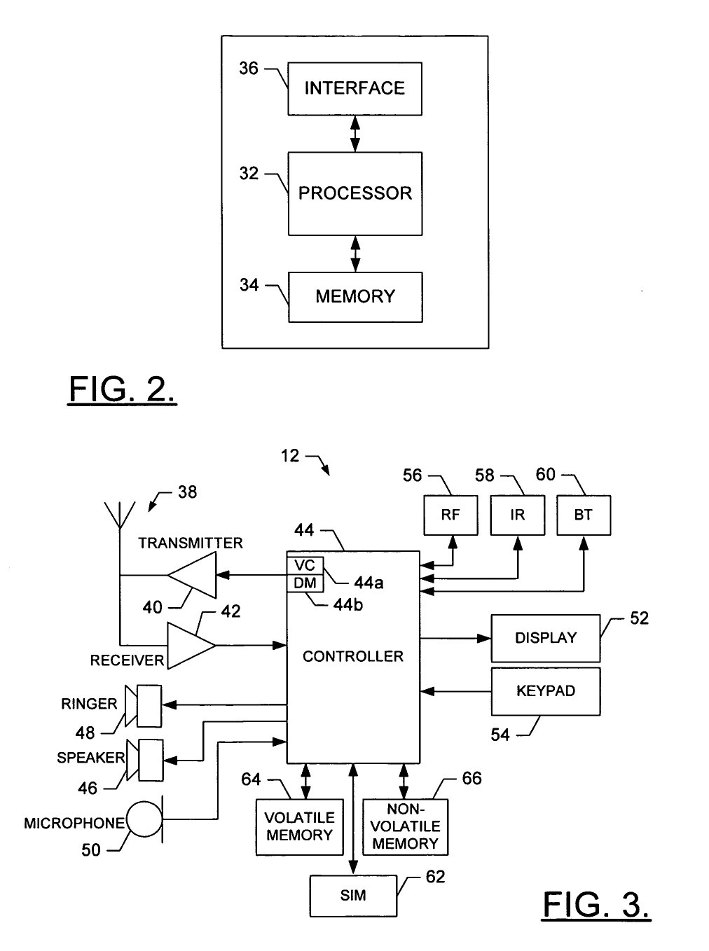

Referring now to FIG. 2, a block diagram of an entity capable of operating as a terminal 12, PDSN 18, server 22, proxy 24 and/or DNS server 26, is shown in accordance with one embodiment of the present invention. Although shown as separate entities, in some embodiments, one or more entities may support one or more of a terminal, PDSN, server, proxy and/or DNS server, logically separated but co-located within the entit(ies). For example, a single entity may support a logically separate, but co-located, server and proxy. As shown, the entity capable of operating as a terminal, PDSN, server, proxy and/or DNS server can generally include a processor 32 connected to a memory 34. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

The processor 32 can also be connected to at least one interface 36 or other means for transmitting and/or receiving data, content or the like. The interface(s) can include a means for communicating in accordance with any one or more of a number of different communication techniques. In this regard, the interface(s) can include means for communicating in accordance with any of a number of wireline and/or wireless communication techniques. For example, the interfaces can generally include an RF module capable of communicating in accordance with an RF communication technique, and can more particularly include a Bluetooth module, WLAN module and/or UWB module capable of communicating in accordance with a Bluetooth, WLAN and/or UWB communication technique, respectively. Additionally or alternatively, the interfaces can include means for communicating in accordance with 1 G, 2 G, 2.5 G and/or 3 G communication techniques.

Reference is now drawn to FIG. 3, which illustrates a block diagram of a mobile terminal 12 in accordance with one embodiment of the present invention. As shown, in addition to an antenna 38, the mobile terminal 12 can include a transmitter 40, receiver 42, and controller 44 or other processor that provides signals to and receives signals from the transmitter and receiver, respectively. These signals include signaling information in accordance with the air interface standard of the applicable cellular system, and also user speech and/or user generated data. In this regard, the mobile terminal can be capable of operating with one or more air interface standards, communication protocols, modulation types, and access types. More particularly, the mobile terminal can be capable of operating in accordance with any of a number of 1 G, 2 G, 2.5 G and/or 3 G communication protocols or the like. For example, the mobile terminal may be capable of operating in accordance with 2G wireless communication protocols IS-136 (TDMA), GSM, IS-95 (CDMA) and cdma2000. Also, for example, the mobile terminal may be capable of operating in accordance with 2.5G wireless communication protocols GPRS, Enhanced Data GSM Environment (EDGE), or the like. Further, for example, the mobile terminal may be capable of operating in accordance with 3G wireless communication protocols such as Universal Mobile Telephone System (UMTS) employing Wideband Code Division Multiple Access (WCDMA) radio access technology. The mobile terminal can also be capable of operating in accordance with enhanced 3G wireless communication protocols such as 1XEV-DO (TIA/EIA.IS-856) and 1XEV-DV. Some narrow-band AMPS (NAMPS), as well as TACS, mobile terminals may also benefit from the teaching of this invention, as should dual or higher mode phones (e.g., digital/analog or TDMA/CDMA/analog phones).

It is understood that the controller 44 includes the circuitry required for implementing the audio and logic functions of the mobile terminal. For example, the controller may be comprised of a digital signal processor device, a microprocessor device, and various analog-to-digital converters, digital-to-analog converters, and/or other support circuits. The control and signal processing functions of the mobile terminal are allocated between these devices according to their respective capabilities. The controller can additionally include an internal voice coder (VC) 44a, and may include an internal data modem (DM) 44b. Further, the controller may include the functionality to operate one or more software programs, which may be stored in memory (described below). For example, the controller may be capable of operating a connectivity program, such as a conventional Web browser. The connectivity program may then allow the mobile terminal to transmit and receive Web content, such as according to the Hypertext Transfer Protocol (HTTP) and/or the Wireless Application Protocol (WAP), for example.

The mobile terminal 12 also comprises a user interface including a conventional earphone or speaker 46, a ringer 48, a microphone 50, a display 52, and-a user input interface, all of which are coupled to the controller 44. The user input interface, which allows the mobile terminal to receive data, can comprise any of a number of devices allowing the mobile terminal to receive data, such as a keypad 54, a touch display (not shown) or other input device. In embodiments including a keypad, the keypad includes the conventional numeric (0-9) and related keys (#, *), and other keys used for operating the mobile terminal. Although not shown, the mobile terminal can include a battery for powering the various circuits that are required to operate the mobile terminal.

As indicated above, the mobile terminal 12 can also include one or more means for sharing and/or obtaining data in accordance with various near-field transfer techniques, and/or wireline and/or wireless networking techniques. As shown in FIG. 3, the mobile terminal can include a short-range RF module 56 comprising an RF transmitter, receiver, transceiver or transponder tag so that data can be shared with and/or obtained from other mobile terminals, fixed terminals or the like that include other RF transmitters, receivers, transceivers, transponder tags, or transceivers capable of operating as a transponder tag. In addition or in the alternative, the mobile terminal can include other short-range modules, such as, for example an IR module 58 (IR transmitter, receiver or transceiver), and/or a Bluetooth module 60 (Bluetooth transmitter, receiver or transceiver), as well as means for transmitting and/or receiving data according to a number of different wireless networking techniques, including WLAN techniques such as IEEE 802.11 techniques or the like.

The mobile terminal 12 can further include memory, such as a subscriber identity module (SIM) 62, a removable user identity module (R-UIM) or the like, which typically stores information elements related to a mobile subscriber. In addition to the SIM, the mobile terminal can include other removable and/or fixed memory. In this regard, the mobile terminal can include volatile memory 64, such as volatile random access memory (RAM) including a cache area for the temporary storage of data. The mobile terminal can also include other non-volatile memory 66, which can be embedded and/or may be removable. The non-volatile memory can additionally or alternatively comprise an EEPROM, flash memory or the like. The memories can store any of a number of pieces of information, and data, used by the mobile terminal to implement the functions of the mobile terminal. The memories can also store one or more applications capable of operating on the mobile terminal.

As explained in the background section, current wireless specifications or protocols do not provide a universal, dynamic technique for the discovery of services available to the mobile terminal 12. In accordance with PPP, for example, the terminal must typically be pre-configured to discover services available to the terminal, such as Web proxy and/or SIP proxy services provided by one or more proxies 24. Microsoft extensions to IPCP do define configuration of DNS and Windows Internet Name Service (WINS) servers, however, such extensions are specific to DNS and WINS services. Also, although DNS SRV records and SLP provide service discovery techniques, such techniques undesirably require additional air-interface traffic to and/or from the terminal.

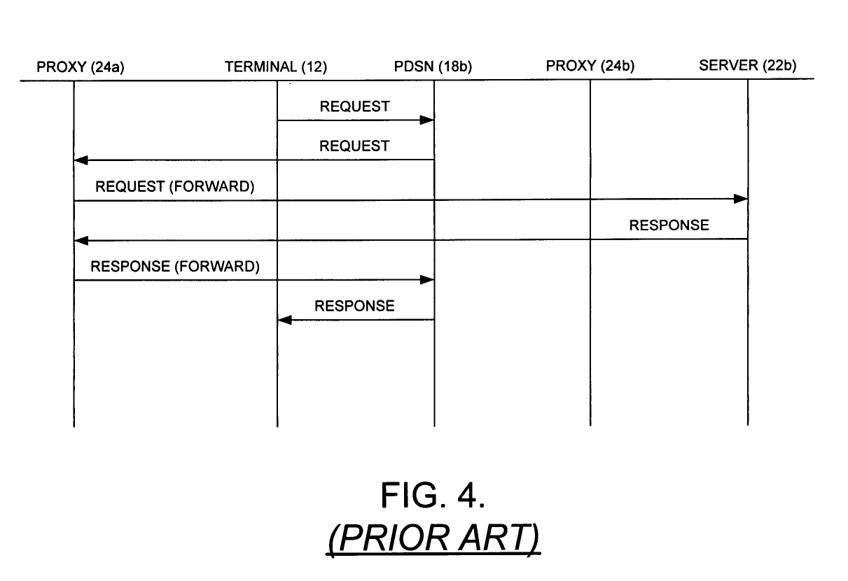

With reference to FIG. 4, consider for example, a terminal 12 that accesses Web content from servers 22 via a Web proxy 24. Also, consider the case when a terminal 12 roams into a visited domain 20b, and the terminal desires to access Web content from a server 22b located in the visited domain. In such instance, in accordance with conventional techniques of pre-configuring the terminal, the terminal's request for the Web content is sent to the Web proxy 24a in the terminal's home domain 20a as opposed to a Web proxy in the visited domain, the Web proxy 24a in the home domain being pre-configured into the terminal. From the Web proxy 24a in the home domain, the request is routed back to the visited domain and server 22b. The server 22b can then respond to the request by sending a response, such as the requested Web content, back to the Web proxy 24a in the home domain, which can then proceed from the Web proxy 24a to the PDSN 18b in the visited domain, and from the PDSN to the terminal.

To overcome the aforementioned drawbacks, embodiments of the present invention therefore provide a system 10, terminal 12 and method for discovering at least one service available to the terminal during connection or link setup or configuration. Advantageously, the system, terminal and method allow the terminal to discover any of a number of available service(s) in a manner that generally does not require pre-configuring the terminal, additional signaling or subsequent network traffic. More particularly, in accordance with embodiments of the present invention, as a terminal configures a network-layer protocol during setup of a connection with another entity, the entity is capable of providing the terminal with a listing of at least one service available to the terminal across the connection, the listing including the service and service address of the service provider. As such, after establishing the connection, the terminal can access one or more of the listed service(s) from the identified service provider(s).

As explained herein, the listing of service(s) and service provider(s) can be provided during establishment of a PPP connection between a terminal 12 and a PDSN 18. It should be understood, however, that the techniques of embodiments of the present invention can be equally applicable to other protocols, such as DHCP, BOOTP and the like. More particularly as explained herein, the listing of service(s) and service provider(s) can be provided during establishment and configuration of IP over a PPP connection, although the techniques of embodiments of the present invention may equally be applicable to establishment and configuration of other network-layer protocols over the connection between the terminal and the PDSN.

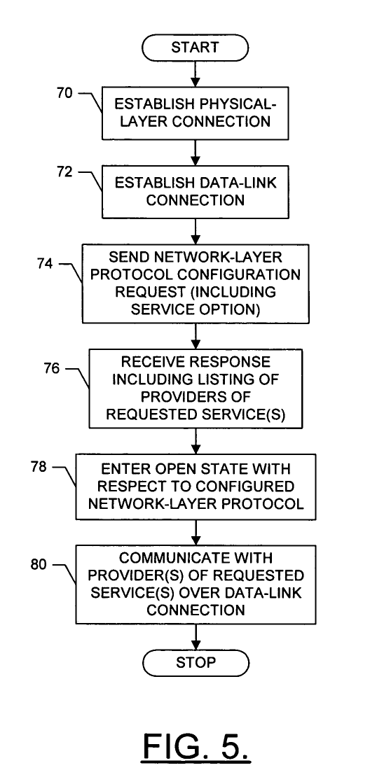

Reference is now made to FIG. 5, which illustrates a flowchart of establishing a connection to a terminal in accordance with one embodiment of the present invention. As shown, the method can include the terminal 12 and an entity such as a PDSN 18 (i.e., PDSN 18a or PDSN 18b) establishing a physical-layer connection therebetween, as shown in block 70. The physical-layer connection can be established in any of a number of different manners. In one embodiment, for example, the physical-layer connection is established in accordance with the cdma2000 standard. Then, after establishing the physical-layer connection, the terminal and PDSN can establish a PPP data-link connection over the physical-layer connection, as shown in block 72. As will be appreciated, the data-link connection can be established in any of a number of different manners, such as in accordance with the Link Control Protocol (LCP), as such is defined in IETF RFC 1661. Although not shown, after establishing the PPP data-link connection, if so desired, the terminal and/or PDSN may authenticate itself to the other of the PDSN and/or terminal.

After establishing the data-link connection (and after authentication, if applicable), the terminal 12 and PDSN 18 can configure a network-layer protocol (e.g., IP) in accordance with a LCP (e.g., IPCP, IP6CP) such that data formatted in accordance with the network-layer protocol can thereafter be sent over the data-link connection. More particularly, the terminal can initiate configuration of the network-layer protocol by requesting to configure the network-layer protocol. In this regard, the terminal can send, and the PDSN can receive, a configure-request across the data-link connection, as such is defined in IETF 1661, as shown in block 74. As will be appreciated, the configure-request can comprise a packet including an identifier and, if so desired, one or more configuration options. In accordance with IPCP, for example, the configuration options can include an IP-compression protocol option and/or an IP-address option (specifying the local address of the terminal). Similarly, in accordance with IP6CP, the configuration options can include an interface-identifier option and/or an IPv6-compression-protocol option.

In accordance with embodiments of the present invention, the configure-request can further include a service option. The service option can identify one or more services the terminal 12 desires to discover and, if desired or otherwise required, the application-layer protocol of one or more of the services the terminal desires to discover. Although the service option can have any of a number of different syntaxes, the service option can be in the syntax “[service]:[application-layer protocol].” For example, to discover a server 22 providing multimedia services, such as a games download server, a software download server or an SLP server, the service option can specify “games:http,” “sw-download:ftp,” or “slp,” respectively. In the preceding, the services are specified as “games,” “sw-download,” and “slp,” and the application-layer protocols are specified as the hypertext transfer protocol (http) and file transfer protocol (ftp) for the games download server and software download server. As shown, the SLP server does not include an application-layer protocol. In such instances, the SLP server can be discovered to thereafter discover other services that are associated with application-layer protocols.

In addition to the aforementioned servers 22, to discover a proxy 24 such as a Web proxy or SIP proxy, the service option can specify “web-proxy:http” or “sip-proxy:http,” respectively, which identifies the desired proxy service and hypertext transfer protocol (http) as the application-layer protocol of the desired proxy service. Alternatively, for example, to discover a proxy operating in accordance with another application-layer protocol such as the real time streaming protocol (RTSP), the service option can specify “streaming-proxy:rtsp.” Also, for example, to discover a DNS server 26, the service option can specify “dns,” which may not include an application-layer protocol since DNS servers typically only operate in accordance with the DNS application-layer protocol. Otherwise, the service option can specify “dns:udp” to include the application-layer protocol (user datagram protocol) of the DNS server service. It should be noted that if the terminal generally desires to discover a number of different available services without regard to the particular services, the service option may be included without specifying any identified services.

Irrespective of the exact syntax of the service option, upon receipt of the configure-request by the PDSN 18, the PDSN can determine if the configuration options of the configure-request are recognizable and acceptable to the PDSN, as such is defined in IETF RFC 1661. The PDSN can then send, and the terminal 12 can receive, a response including a listing of one or more of the requested services, as well as the addresses of the service providers (e.g., IP address and, if so desired or required, port number and/or pathname for accessing the service at the service provider), as shown in block 76. Additionally or alternatively, the response can include, in the listing, one or more services not otherwise requested in the configure-request, particularly when the service option of the configure-request is sent without specifying any identified services. As will be appreciated, the PDSN can be configured to store a listing of services available in the domain 20 of the PDSN, or otherwise be configured to determine such services. For example, when the configure-request includes a respective service option, the PDSN can send a response including any one or more of the following:
service:games:http://192.168.0.200:15001/games/download/
service:sw-download:ftp://192.168.0.225/software/download/
service:slp://192.168.0.2/
service:web-proxy:http://192.168.0.1:8080/
service:web-proxy-curl:http://192.168.0.1:8080/proxy.pac/
service:sip-proxy:http://192.168.0.11:5060/
service:streaming-proxy:rtsp://192.168.0.10:554/
service:dns://192.168.0.100/
   As can be seen, the response can identify one or more of the service(s) requested in the service option, each identified service including the IP address (e.g., 192.168.0.xxx) of the service provider providing the service, and if so desired or otherwise required, the port number (e.g., port 15001 of the games download server), and/or the pathname of the service (e.g., /games/download). It is noted that, although not indicated in the example listing of requested services above, when the service option requests a service such as a Web proxy, the PDSN can respond with a configuration address (web-proxy-curl) of the service.

It is also noted that the syntax of the service option and/or response listing given herein is merely for illustrative purposes, and should not be taken to limit the scope of the present invention. For example, the service option can include binary encoded information, such as addresses (four octets in IPv4) and port numbers (two octets for IPv4), as opposed to names or text strings such as “192.168.0.1:5060” (sixteen octets). In such instances, the octet sequences can be arranged in any of a number of different manners, such as in network byte order, Big-endian byte order or the like. Also, for example, the service option syntax could be configured to avoid the use of a service option header (e.g., “service,”) such as by including an identifier interpretable as a service option header. Additionally or alternatively, for example, the syntax could be configured to avoid the use of application-layer headers (e.g., “http”), also such as by including an identifier interpretable as an application-layer (e.g., integer one could be included in place of, and interpreted as representing, “http”).

The PDSN 18 can be configured to send a configure-ack response to the terminal 12, the configure-ack indicative of the configuration options being recognizable and acceptable to the PDSN. Similar to the configure-request, the configure-ack can comprise a packet including an identifier matching that of the configure-request, as well as the configuration options the PDSN is acknowledging. Thus, for the service option, the configure-ack packet can include the listing of service(s) and the associated service provider address(es). Alternatively, as configure-request typically includes configuration values and values for those options, and as the service option typically does not include address(s) for the service provider(s) of the desired service(s) since the service option requests the identit(ies) of those service provider(s), the PDSN can be configured to send a configure-nak response to the terminal, as such is defined in IETF RFC 1661. In such an instance, like the configure-ack, the configure-nak can include the listing of service(s) and the associated service provider address(es).

Upon receipt of the response from the PDSN 18, the terminal 12 and PDSN can continue to configure the network-layer protocol, if so desired or otherwise required. For example, the terminal can continue to configure the network-layer protocol by sending another configure-request in instances where the PDSN responds to the previous configure-request with a configure-nak. In such instances, as the terminal previously received the listing of available services, the terminal need not include the service option in the subsequent configure-request. Irrespective of whether, or how, the terminal and PDSN continue to configure the network-layer protocol, after the network-layer protocol is configured, the terminal and PDSN can enter the open state with respect to the configured network-layer protocol, as shown in block 78. While in the open state, then, the terminal and PDSN can send data from the configured network-layer protocol (e.g., IP) over the data-link connection therebetween.

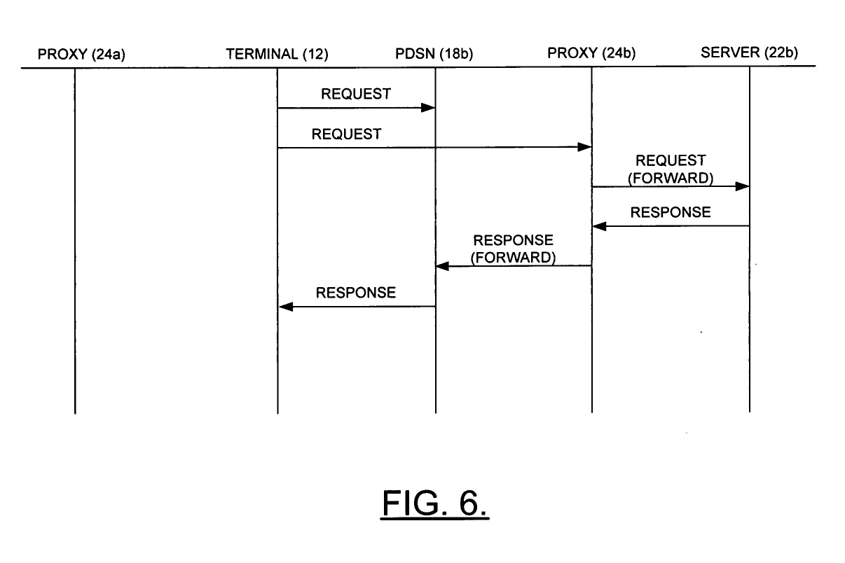

By enabling the terminal 12 to send data to the PDSN 18 over the data-link connection, the terminal can communicate with one or more of the discovered service providers to thereby access the service(s) provided by the respective service providers, as shown in block 80. To further illustrate the benefits of embodiments of the present invention, again consider a terminal that accesses Web content from servers 22 via a Web proxy 24. Also, consider again the case when a terminal 12 roams into a visited domain 20b, and the terminal desires to access Web content from a server 22b located in the visited domain. Further, in accordance with embodiments of the present invention, consider that, during connection or link setup or configuration with the PDSN 18b of the visited domain, the terminal performed service discovery to discover a Web proxy 24b located in the visited domain, in accordance with embodiments of the present invention. As shown in FIG. 6, then, the terminal's request for the Web content is sent to the Web proxy 24b in the terminal's visited domain 20a as opposed to the Web proxy 24a in the home domain, as is the case in accordance with conventional techniques (see FIG. 4). Then, from the Web proxy 24b in the visited domain, the request can be routed only within the visited domain to server 22b. The server 22b can then respond to the request by sending a response, such as the requested Web content, back to the Web proxy 24b in the visited domain. The response can then be forwarded from the Web proxy 24a to the PDSN 18b in the visited domain, and from the PDSN to the terminal. Thus, in accordance with embodiments of the present invention, the entire transaction between the terminal and the server providing Web content can occur within the visited domain, without accessing services in the terminal's home domain.

According to one aspect of the present invention, all or a portion of the system of the present invention, such all or portions of the terminal 12 and/or PDSN 18, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 5 and 6 are flowcharts and control flow diagrams of methods, systems and program products according to the invention. It will be understood that each block or step of the flowcharts and control flow diagrams, and combinations of blocks in the flowcharts and control flow diagrams, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts and control flow diagrams. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts and control flow diagrams. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts and control flow diagrams.

Accordingly, blocks or steps of the flowcharts and control flow diagrams support combinations of means for performing the specified functions, combinations of steps for performing the specified functions and program instruction means for performing the specified functions. It will also be understood that each block or step of the flowcharts and control flow diagrams, and combinations of blocks or steps in the flowcharts and control flow diagrams, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system comprising:
a network entity; and
a terminal capable of establishing a data-link connection with the network entity;
wherein the network entity and the terminal are capable of configuring a network-layer protocol such that data formatted in accordance with the network-layer protocol can thereafter be sent between the terminal and the network entity over the data-link connection,
wherein the terminal is capable of discovering at least one service available to the terminal during configuration of the network-layer protocol by receiving, from the network entity, a listing of the at least one available service, the listing of each available service including an address of a provider of the available service and at least one of a port number and a pathname for accessing the service at the provider.

2. A system according to claim 1, wherein the terminal is capable of sending, to the network entity, a configure request including a service option identifying at least one service, wherein the network entity is capable of sending, to the terminal, a response including the listing of the at least one available service such that the terminal is capable of discovering the at least one available service based upon the response, and wherein the terminal is capable of sending the configure request and the network entity is capable of sending the response to thereby configure the network-layer protocol.

3. A system according to claim 2, wherein the terminal is capable of sending a configure request including a service option further identifying an application-layer protocol of at least one of the identified services.

4. A system according to claim 1, wherein the terminal is capable of discovering a Web proxy service available to the terminal during configuration of the network-layer protocol.

5. A system according to claim 1, wherein the terminal is capable of discovering at least one multimedia service available to the terminal during configuration of the network-layer protocol.

6. A system according to claim 1, wherein the terminal is capable of discovering a service location protocol (SLP) service available to the terminal during configuration of the network-layer protocol.

7. A system according to claim 1, wherein the terminal is capable of discovering a session initiation protocol (SIP) proxy service available to the terminal during configuration of the network-layer protocol.

8. A terminal for establishing a connection with a network entity, the terminal comprising:
a processor capable of establishing a data-link connection between the terminal and a network entity,
wherein the processor is also capable of configuring a network-layer protocol with the network entity such that data formatted in accordance with the network-layer protocol can thereafter be sent between the terminal and the network entity over the data-link connection,
wherein the processor is capable of discovering at least one service available to the terminal during configuration of the network-layer protocol by receiving, from the network entity, a listing of the at least one available service, the listing of each available service including an address of a provider of the available service and at least one of a port number and a pathname for accessing the service at the provider.

9. A terminal according to claim 8, wherein the processor is capable of configuring the network-layer protocol by sending a configure request to the network entity, the configure request including a service option identifying at least one service, and by thereafter receiving a response from the network entity, the response including the listing of the at least one available service.

10. A terminal according to claim 9, wherein the processor is capable of sending a configure request including a service option further identifying an application-layer protocol of at least one of the identified services.

11. A terminal according to claim 8, wherein the processor is capable of discovering a Web proxy service available to the terminal during configuration of the network-layer protocol.

12. A terminal according to claim 8, wherein the processor is capable of discovering at least one multimedia service available to the terminal during configuration of the network-layer protocol.

13. A terminal according to claim 8, wherein the processor is capable of discovering a service location protocol (SLP) service available to the terminal during configuration of the network-layer protocol.

14. A terminal according to claim 8, wherein the processor is capable of discovering a session initiation protocol (SIP) service available to the terminal during configuration of the network-layer protocol.

15. A network entity for establishing a connection from a terminal, the network entity comprising:
a processor capable of establishing a data-link connection between the terminal and the network entity,
wherein the processor is also capable of configuring a network-layer protocol with the terminal such that data formatted in accordance with the network-layer protocol can thereafter be sent between the terminal and the network entity over the data-link connection, wherein the processor is capable of configuring the network-layer protocol such that the terminal is capable of discovering at least one service available to the terminal during configuration of the network-layer protocol, and
wherein the processor is capable of sending a listing of the at least one available service to the terminal during configuration of the network-layer protocol such that the terminal is capable of discovering at least one available service based upon the listing, the listing of each available service including an address of a provider of the available service and at least one of a port number and a pathname for accessing the service at the provider.

16. A network entity according to claim 15, wherein the processor is capable of configuring the network-layer protocol by receiving a configure request from the terminal, the configure request including a service option identifying at least one service, and by thereafter sending a response to the terminal, the response including the listing of the at least one available service.

17. A network entity according to claim 16, wherein the processor is capable of receiving a configure request including a service option further identifying an application-layer protocol of at least one of the identified services.

18. A network entity according to claim 15, wherein the processor is capable of sending a listing of the at least one available service to the terminal during configuration of the network-layer protocol such that the terminal is capable of discovering a Web proxy service available to the terminal.

19. A network entity according to claim 15, wherein the processor is capable of sending a listing of the at least one available service to the terminal during configuration of the network-layer protocol such that the terminal is capable of discovering at least one multimedia service available to the terminal.

20. A network entity according to claim 15, wherein the processor is capable of sending a listing of the at least one available service to the terminal during configuration of the network-layer protocol such that the terminal is capable of discovering a service location protocol (SLP) service available to the terminal.

21. A network entity according to claim 15, wherein the processor is capable of sending a listing of the at least one available service to the terminal during configuration of the network-layer protocol such that the terminal is capable of discovering a session initiation protocol (SIP) service available to the terminal.

22. A method of establishing a connection to a terminal, the method comprising:
establishing a data-link connection between the terminal and a network entity; and
configuring a network-layer protocol such that data formatted in accordance with the network-layer protocol can thereafter be sent between the terminal and the network entity over the data-link connection, wherein configuring the network-layer protocol includes discovering at least one service available to the terminal, and wherein discovering at least one available service comprises receiving, at the terminal, a listing of the at least one available service, the listing of each available service including an address of a provider of the available service and at least one of a port number and a pathname for accessing the service at the provider.

23. A method according to claim 22, wherein configuring a network-layer protocol comprises:
sending a configure request to the network entity, the configure request including a service option identifying at least one service; and
receiving a response including the listing of the at least one available service.

24. A method according to claim 23, wherein sending a configure request comprises sending a configure request including a service option further identifying an application-layer protocol of at least one of the identified services.

25. A method according to claim 22, wherein discovering at least one service comprises discovering a Web proxy service.

26. A method according to claim 22, wherein discovering at least one service comprises discovering at least one multimedia service.

27. A method according to claim 22, wherein discovering at least one service comprises discovering a service location protocol (SLP) service.

28. A method according to claim 22, wherein discovering at least one service comprises discovering a session initiation protocol (SIP) service.

29. A method according to claim 22, wherein receiving a listing of the at least one available service comprises receiving the listing of each available service including an address of a provider and at least one of a port number and a pathname, at least one of the address, port number and pathname being binary encoded.
